(19) United States
(12) Patent Application Publication
(10) Pub. No.: US 2015/0138172 A1
(43) Pub. Date: May 21, 2015

(54) DISPLAY DEVICE

(71) Applicant: SAMSUNG DISPLAY CO., LTD., Yongin-City (KR)

(72) Inventor: Hak Gyu Kim, Hwaseong-si (KR)

(21) Appl. No.: 14/328,650

(22) Filed: Jul. 10, 2014

(30) Foreign Application Priority Data
Nov. 20, 2013 (KR) 10-2013-0141510

(51) Int. Cl. G09G 5/18; G09G 3/32; G09G 3/36

(52) U.S. Cl. CPC G09G 5/18; G09G 3/3696; G09G 3/3208
USPC 345/205; 345/103; 345/82

(57) ABSTRACT

A display device including: a circuit board including a signal controller, a display panel including a plurality of driving IC circuits, a flexible printed circuit board coupling the circuit board to the display panel, and a plurality of signal lines respectively coupled to the signal controller and the plurality of driving IC circuits through the circuit board, the flexible printed circuit board, and the display panel. Each of the plurality of signal lines includes a COG resistance, a FOG resistance, and a FOB resistance. The signal controller applies a first signal to any one of the plurality of driving IC circuits, the any one of the plurality of driving IC circuits short-circuits the respectively coupled signal line when the first signal is received, and the signal controller measures the COG resistance, the FOG resistance, and the FOB resistance when the respectively coupled signal line is short-circuited.

### CROSS-REFERENCE TO RELATED APPLICATION

This application claims priority to and the benefit of Korean Patent Application No. 10-2013-0141510, filed in the Korean Intellectual Property Office on Nov. 20, 2013, the entire content of which is incorporated herein by reference.

### BACKGROUND

1. Field

An aspect of an embodiment of the present invention relates to a display device.

2. Description of the Related Art

A display device includes a display panel. Further, the display panel may be divided into a display unit and a non-display unit. The display unit includes a plurality of pixels defined by crossing a plurality of gate lines and data lines, and the non-display unit, which is the outside of the display unit, includes data pads and gate pads formed at ends of the gate lines and the data lines, respectively, to interface an electric signal of the display unit with an external driving element. The driving element includes a chip or substrate for driving the display panel, for example, a driving integrated circuit (IC) (hereinafter, referred to as D-IC), a flexible printed circuit (FPC) (hereinafter, referred to as FPC), and the like.

Methods of mounting the D-IC on the display panel includes a chip on glass (hereinafter, referred to as COG) method, a tape carrier package (hereinafter, referred to as TCP) method, and a chip on film (hereinafter, referred to as COF) method. Among these methods, the COG method has recently been widely used, because the COG method has a simple structure as compared with the TCP method and COF method, and may help increase a ratio occupied by the display panel in the display device.

With respect to the COG method, a coupling resistance RCOG (or COG resistor, and hereinafter, referred to as ‘COG resistor’) is formed by coupling of the display panel and the driving IC circuit. However, a problem in that the COG resistance is increased due to an error of the COG resistance according to a COG process distribution, an IC bump shape, a pad resistance distribution, and the like may occur, and a defect in performance of the display device may be caused. Therefore, it may be important to determine an error of the COG resistance during processing.

Further, for substantially the same reasons as those discussed above, it may be important to determine an error of a coupling resistance RFOG (or FOG resistor, and hereinafter, referred to as ‘FOG resistance’) formed by coupling of the display panel and the FPC, or a coupling resistance RFOB (or FOB resistor, and hereinafter, referred to as ‘FOB resistance’) formed by coupling of the FPC and a circuit board (PCB).

The above information disclosed in this Background section is only for enhancement of understanding of the background of the invention and, therefore, may contain information that does not form the prior art that is already known in this country to a person of ordinary skill in the art.

### SUMMARY

Aspects of embodiments of the present invention are directed toward a display device configured to determine an error of a COG resistance, an error of a FOG resistance, and/or an error of a FOB resistance.

An embodiment of the present invention provides a display device, including: a circuit board including a signal controller, a display panel including a plurality of driving IC circuits, a flexible printed circuit board coupling (e.g., connecting) the circuit board and the display panel, and a plurality of signal lines respectively coupled (e.g., connected) to the signal controller and the plurality of driving IC circuits through the circuit board, the flexible printed circuit board, and the display panel. Each of the plurality of signal lines includes a COG resistance by coupling of the display panel and the driving IC circuit, a FOG resistance by coupling of the display panel and the flexible printed circuit board, and a FOB resistance by coupling of the flexible printed circuit board and the circuit board. The signal controller is configured to apply a first signal to any one of the plurality of driving IC circuits, the any one of the plurality of driving IC circuits configured to short-circuit the respectively coupled (e.g., connected) signal line when the first signal is received, and the signal controller is further configured to measure the COG resistance, the FOG resistance, and the FOB resistance when the respectively coupled signal line is short-circuited.

Each of the plurality of driving IC circuits may include a latch.

The latch may be configured to receive the first signal to short-circuit the signal line coupled to the driving IC circuit including the latch, and to apply an operation voltage VDD to the coupled signal line.

The latch may be further configured to transfer the first signal to a next latch, and to open the short-circuited signal line when the signal controller measures a first coupling resistance, a second coupling resistance, and a third coupling resistance of the short-circuited signal line.

The signal controller may include first to third resistances, and

The first resistance may be coupled to the FOB resistance, the second resistance may be coupled to the FOG resistance, and the third resistance may be coupled to the COG resistance.

The first to third resistances may be a same size as each other.

The signal controller may be configured to measure a contact point voltage V_{P1} of the FOB resistance and the first resistance, a contact point voltage V_{P2} of the FOB resistance and the FOG resistance, and a contact point voltage V_{P3} of the FOG resistance and the COG resistance, and the signal controller may be further configured to measure the FOB resistance, the FOG resistance, and/or the COG resistance according to (e.g., based on) Equations 1 to 3:

V_{P1}=(VDD*first resistance)/((COG resistance+FOG resistance+FOB resistance)+first resistance) Equation 1

V_{P2}=(VDD*first resistance)/((COG resistance+FOG resistance)+first resistance) Equation 2

V_{P3}=(VDD*first resistance)/((COG resistance+first resistance) Equation 3

The signal controller may further include a resistance measuring unit configured to measure the FOB resistance, the FOG resistance, and/or the COG resistance.

The resistance measuring unit may include an A/D converter and a register. The A/D converter may be configured to convert a measured voltage value into a digital value by measuring the V_{P1}, the V_{P2}, and the V_{P3}. The register may be configured to store the measured voltage value converted into the digital value.

The resistance measuring unit may be configured to measure the FOB, FOG, and/or COG resistances based on Equations 1 to 3.

The signal controller may include first to third capacitors, and the first capacitor may be coupled (e.g., connected) to the FOB resistance, the second capacitor may be coupled to the FOG resistance, and the third capacitor may be coupled to the COG resistance.

The first to third capacitors may be a same size as each other.

The signal controller may be configured to measure a target voltage delay time T_{P1} of the contact point voltage of the FOB resistance and the first capacitor, a target voltage delay time T_{P2} of the contact point voltage of the FOB resistance and the FOG resistance, and a target voltage delay time T_{P3} of the contact point voltage of the FOG resistance and the COG resistance, and the signal controller may be further configured to measure the FOB resistance, the FOG resistance, and/or the COG resistance based on Equations 4 to 6:

T_{P1}=a*((COG resistance+FOG resistance+FOB resistance)+first capacitor) Equation 4
(wherein a is a coefficient)

T_{P2}=a*((COG resistance+FOG resistance)+first capacitor) Equation 5
(wherein a is a coefficient)

T_{P3}=a*((COG resistance)+first capacitor) Equation 6

(wherein a is a coefficient).

The signal controller may further include a resistance measuring unit configured to measure the FOB resistance, the FOG resistance, and the COG resistance.

The resistance measuring unit may further include a comparator, a counter, and a register. The comparator may be configured to compare measured voltage values with a target voltage, by measuring a contact point voltage of the FOB resistance and the first capacitor, a contact point voltage of the FOB resistance and the FOG resistance, and a contact point voltage of the FOG resistance and the COG resistance. The counter may be configured to measure the T_{P1}, the T_{P2}, and the T_{P3}. The register may be configured to store the measured delay times.

The resistance measuring unit may be configured to measure the FOB, FOG, and/or COG resistances based on Equations 4 to 6.

According to an embodiment of the present invention, it may be possible to determine an error of a COG resistance, an error of a FOG resistance, and/or an error of a FOB resistance.

### BRIEF DESCRIPTION OF THE DRAWINGS

FIG. 1 is a block diagram of a display device according to an embodiment of the present invention.

FIG. 2 is a diagram schematically illustrating a display device according to an embodiment of the present invention.

FIG. 3 is a diagram schematically illustrating a connection relationship between a D-IC and a signal controller, when a VDD is applied to any one connection signal line of the display device of an embodiment of FIG. 2.

FIG. 4 is a diagram schematically illustrating a display device according to another embodiment of the present invention.

FIG. 5 is a diagram schematically illustrating a connection relationship between a D-IC and a signal controller, when a VDD is applied to any one connection signal line of the display device of an embodiment of FIG. 4.

FIG. 6 is a diagram schematically illustrating a resistance measuring unit according to an embodiment of the present invention.

FIG. 7 is a diagram schematically illustrating a resistance measuring unit according to another embodiment of the present invention.

FIG. 8 is a diagram illustrating a voltage delay of a measuring node N of an embodiment of the present invention.

### DETAILED DESCRIPTION

Embodiments of the present invention will be described hereinafter with reference to the accompanying drawings. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals designate like elements throughout the specification. It will be understood to those skilled in the art that when an element such as a layer, film, region, or substrate is referred to as being “on” another element, it can be directly on the other element or other intervening elements may also be present. In contrast, when an element is referred to as being “directly on” another element, there are no intervening elements present.

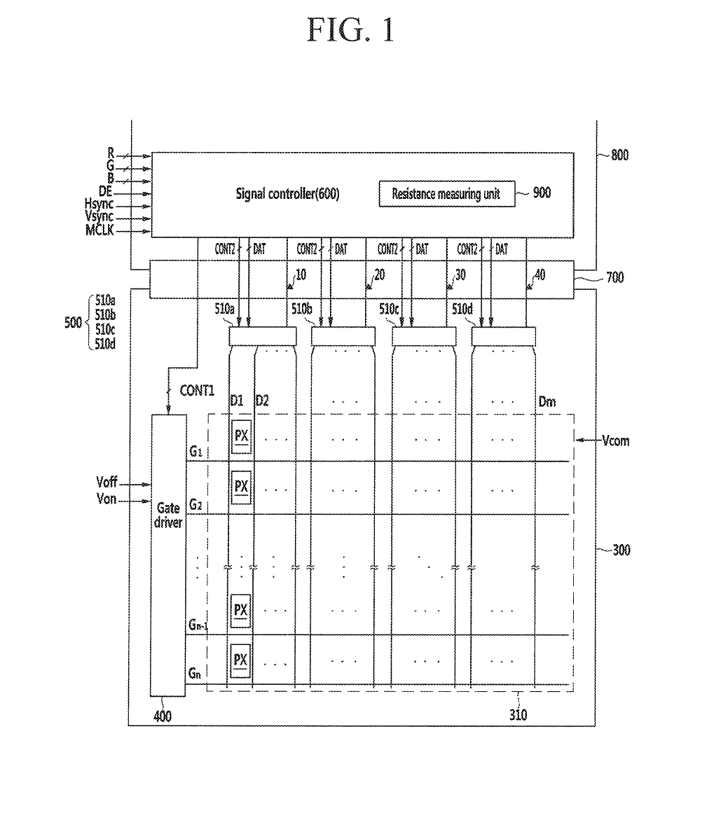

First, a display device according to an example embodiment of the present invention will be described with reference to FIG. 1.

FIG. 1 is a block diagram of a display device according to an embodiment of the present invention.

Referring to FIG. 1, a display device according to an embodiment of the present invention includes a display panel 300, an FPC 700 (referred to as a flexible printed circuit board), and a circuit board 800. The circuit board 800 according to an embodiment of the present invention includes a signal controller 600.

The display panel 300 may be coupled to (e.g., connected to) the circuit board 800 through the FPC 700.

The display panel 300 includes a display area 310, a gate driver 400, and a data driver 500. The data driver 500 according to an embodiment of the present invention includes a plurality of D-ICs 510a, 510b, 510c, and 510d (referred to as driving IC circuits). Hereinafter, four D-ICs 510a, 510b, 510c, and 510d are described, but the present invention is not limited thereto, and more or less number of D-ICs may be applied.

According to an embodiment of the present invention, connection signal lines 10, 20, 30, and 40 coupled to the signal controller 600 protrude from the signal controller 600 to be coupled to the D-ICs 510a, 510b, 510c, and 510d through the circuit board 800, the FPC 700, and a part of the display panel 300, respectively. According to an embodiment of the present invention, the connection signal lines 10, 20, 30, and 40 may respectively correspond with the D-ICs 510a, 510b, 510c, and 510d, in a one-to-one relationship. That is, the connection signal lines 10, 20, 30, and 40 couple the signal controller 600 to the D-ICs 510a, 510b, 510c, and 510d, and include a portion at the circuit board 800, a portion at the FPC 700, and a portion on one substrate of the display panel 300.

The display area 310 includes a plurality of signal lines G₁-Gₙ and D₁-Dₘ, and a plurality of pixels PX arranged substantially in a matrix form. The gate driver 400 and the data driver 500 are coupled to the plurality of signal lines G₁-Gₙ and D₁-Dₘ.

The signal lines G₁-Gₙ and D₁-Dₘ respectively include a plurality of gate lines G1-Gn transferring gate signals (referred to as “scanning signals”), and a plurality of data lines D1-Dm transferring data voltages. The gate lines G₁-Gₙ extend substantially in a row direction and are almost (e.g., substantially) parallel to each other, and the data lines D₁-Dₘ extend substantially in a column direction and are almost (e.g., substantially) parallel to each other.

The pixel PX includes a switching element such as a thin film transistor connected to the plurality of gate lines G₁-Gₙ and the plurality of data lines D₁-Dₘ, and may have various structures according to an embodiment. That is, the organic light emitting panel may further include an organic light emitting diode, and the liquid crystal panel may further include a liquid crystal capacitor.

Meanwhile, in order to implement color display, each pixel PX may display one of the primary colors (e.g., spatial division), or alternately, may display the primary colors with time (e.g., temporal division) so that a desired color is recognized by the spatial and temporal sum of the primary colors. An example of the primary colors may include three primary colors such as red, green, and blue.

The gate driver 400 may be coupled to the gate lines G₁-Gₙ of the display panel 300 to apply gate signals configured by combining a gate-on voltage Von and a gate-off voltage Voff to the gate lines G₁ . . . Gₙ.

The data driver 500 may be coupled (e.g., connected) to the data lines D₁-Dₘ of the display panel 300, and may be configured to select gray voltages to apply the selected gray voltages to the data lines D₁-Dₘ as data voltages. The data driver 500 may generate a desired data voltage by dividing a reference gray voltage.

The switch controller 600 according to an embodiment of the present invention includes a resistance measuring unit 900 measuring a size of a resistance.

The signal controller 600 may control the gate driver 400, the data driver 500, and the like.

Each of the driving devices 400, 500, and 600 may be directly or indirectly mounted on the display panel 300 in at least one IC chip form, may be mounted on a flexible printed circuit film to be coupled to (e.g., attached to) the display panel 300 in a tape carrier package (TCP) form, or may be mounted on a separate printed circuit board.

An example embodiment in which the display panel 300 and the D-ICs 510a, 510b, 510c, and 510d are mounted by the COG method will be described. However, the present invention is not limited thereto, and may be applied to embodiments where the D-ICs 510a, 510b, 510c, and 510d are mounted on the display panel 300 by another method.

Next, an operation of an embodiment of the display device will be described.

The signal controller 600 may receive input image signals R, G, and B, and an input control signal for controlling a display of the input image signals R, G, and B from an external graphic controller. The input image signals R, G, and B may store luminance information of each pixel PX, and the luminance may have a set (e.g., predetermined) number of grays, for example, 1024 (=2¹⁰), 256 (=2⁸), or 64 (=2⁶) grays. An example of the input control signal includes a vertical synchronization signal Vsync, a horizontal synchronization signal Hsync, a main clock MCLK, a data enable signal DE, and the like.

The signal controller 600 processes the input image signals R, G, and B in accordance with the operational condition of the display panel 300 based on the input image signals R, G, and B and the input control signal. The signal controller 600 may generate a gate control signal CONT1 and a data control signal CONT2. The signal controller 600 may transmit the gate control signal CONT1 to the gate driver 400, and transmit the data control signal CONT2 and a processed image signal DAT to the data driver 500.

The gate control signal CONT1 may include a scanning start signal STV to instruct scanning start, and may include at least one clock signal to control an output period of the gate-on voltage Von. The gate control signal CONT1 may further include an output enable signal OE to limit a duration time of the gate-on voltage Von.

The data control signal CONT2 may include a horizontal synchronization start signal STH to notify a transmission start of the digital image signal DAT for pixels PX in one row. The data control signal CONT2 may further include a load signal LOAD to instruct an analog data voltage to be applied to the data lines D₁-Dₘ, and a data clock signal HCLK.

According to the data control signal CONT2 from the signal controller 600, the data driver 500 receives the digital image signal DAT for pixels PX in one row. The data driver 500 selects a gray voltage corresponding to each digital image signal DAT, and converts the digital image signal DAT into an analog data voltage. The data driver 500 applies the converted analog data voltage to the corresponding data lines D₁-Dₘ.

The gate driver 400 applies the gate-on voltage Von to the gate lines G₁-Gₙ according to the gate control signal CONT1 from the signal controller 600, to turn on the switching elements Q connected to the gate lines G₁-Gₙ. Then, the data voltages applied to the data lines D₁-Dₘ are applied to the corresponding pixels PX through the turned-on switching elements Q.

Luminance displayed by the pixel PX may be changed according to the data voltage applied to the pixel PX to display a gray.

The process is repeated by setting 1 horizontal period [referred to as “1H”, and being the same as one period of a horizontal synchronization signal Hsync and a data enable signal DE] by a unit, and as a result, the gate-on voltages Von are sequentially applied to all the gate lines G₁-Gₙ, and the data voltages are applied to all the pixels PX to display images for one frame.

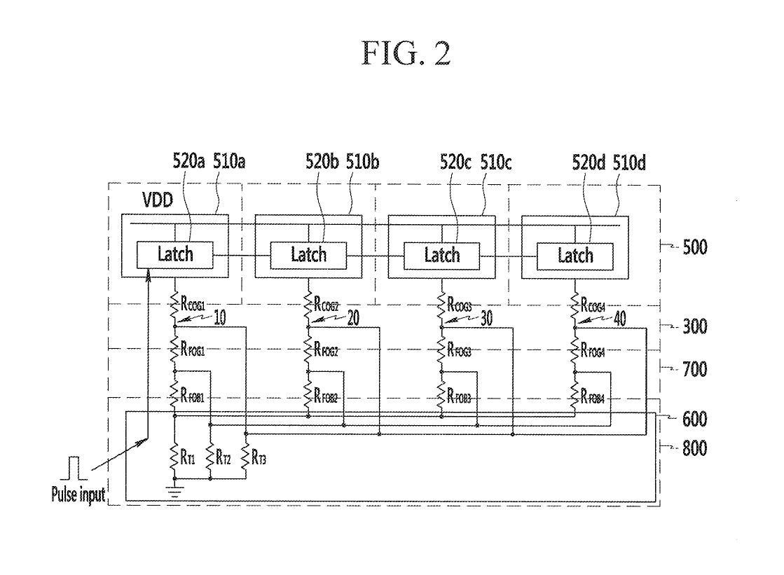

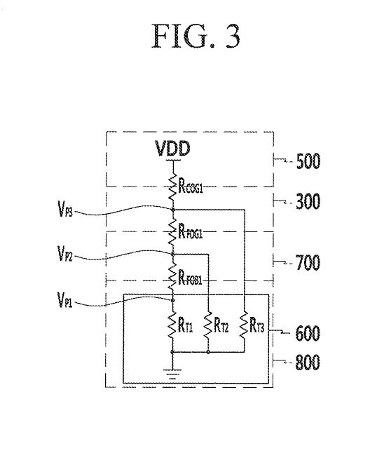

Next, an operating method of the display device according to an embodiment of the present invention will be described with reference to FIGS. 2 and 3.

FIG. 2 is a diagram schematically illustrating a display device according to an embodiment of the present invention. The top and bottom of FIG. 2 are opposite to the top and bottom of FIG. 1.

Referring to FIG. 2, a configuration of a display device according to an embodiment of the present invention will be described. The D-ICs 510a, 510b, 510c, and 510d according to an embodiment of the present invention include latches 520a, 520b, 520c, and 520d, respectively. Further, the D-ICs 510a, 510b, 510c, and 510d may be coupled (e.g., connected) to the signal controller 600 through the connection signal lines 10, 20, 30, and 40, respectively.

Each of the connection signal lines 10, 20, 30, and 40 may include a COG resistance R_{COG1-4}, a FOG resistance R_{FOG1-4}, and a FOB resistance R_{FOS1-4}, which are respectfully coupled to each other in series. That is, the FOB resistance R_{FOB1-4} is a resistance by coupling between a portion on the circuit board 800 and a portion on the FPC 700 among the connection signal lines 10, 20, 30, and 40, the FOG resistance R_{FOG1-4} is a resistance by coupling between the FPC 700 and one substrate (lower substrate) of the display panel 300, and the COG resistance R_{COG1-4} is a resistance of a portion on the lower substrate of the display panel 300, that is, a resistance by coupling between the display panel 300 and the D-IC.

Further, resistances of the portion at the circuit board 800 are respectively represented by first to third resistances R_{T1}, R_{T2}, and R_{T3}. That is, the signal controller 600 includes the first to third resistances R_{T1}, R_{T2}, and R_{T3}, which may be coupled to each other in parallel. The sizes of the first to third resistances R_{T1}, R_{T2}, and R_{T3}, according to an embodiment of the present invention, may be substantially equivalent to (e.g., the same as) each other. Further, the first to third resistances R_{T1}, R_{T2}, and R_{T3} may be constants. One end of the first resistance R_{T1} may be coupled to one end of each FOB resistance R_{FOB1-4}. The other end of each FOB resistance R_{FOB1-4} may be coupled to one end of each FOG resistance R_{FOG1-4}. Further, one end of each FOG resistance R_{FOG1-4} may be coupled to one end of the second resistance R_{T2}. The other end of each FOG resistance R_{FOG1-4} may be coupled to one end of COG resistance R_{COG1-4}

The other end of each FOG resistance R_{FOG1-4} may be further coupled to one end of the third resistance RT3. The other end of each COG resistance R_{COG1-4} may be coupled to each of the D-ICs 510a, 510b, 510c, and 510d. The other ends of the first to third resistances R_{T1}, R_{T2}, and R_{T3} may be grounded.

Next, an operation of the display device according to an embodiment of the present invention will be described.

The signal controller 600 applies a pulse signal to the first latch 520a. The first latch 520a short-circuits the first connection signal line 10 in response to the pulse signal, to apply an operation voltage VDD to the first connection signal line 10. The remaining signal lines 20, 30, and 40, except for the first connection signal line 10, are in an open state. Thereafter, the signal controller 600 determines an error of each of the resistances R_{COG1}, R_{FOG1}, and R_{FOB1}, based on the operation voltage VDD applied to the first connection signal line 10. Thereafter, the first latch 520a applies the pulse signal to the second latch 520b. When the first latch 520a applies the pulse signal to the second latch 520b, the first latch 520a stops applying the operation voltage VDD to the first connection signal line 10. That is, the first latch 520a opens the first connection signal line 10.

The second latch 520b short-circuits the second connection signal line 20 in response to the pulse signal applied from the first latch 520a, to apply the operation voltage VDD to the second connection signal line 20. The remaining signal lines 10, 30, and 40, except for the second connection signal line 20, are in an open state. Thereafter, the signal controller 600 determines an error of each of the resistances R_{COG2}, R_{FOG2}, and R_{FOB2}, based on the operation voltage VOID applied to the second connection signal line 20. Thereafter, the second latch 520b applies the pulse signal to the third latch 520c. When the second latch 520b applies the pulse signal to the third latch 520c, the second latch 520b stops applying the operation voltage VDD to the second connection signal line 20. That is, the second latch 520b opens the second connection signal line 20.

The third latch 520c short-circuits the third connection signal line 30 in response to the pulse signal applied from the second latch 520b, to apply the operation voltage VDD to the third connection signal line 30. The remaining signal lines 10, 20, and 40, except for the third connection signal line 30, are in an open state. Thereafter, the signal controller 600 determines an error of each of the resistances R_{COG3}, R_{FOG3}, and R_{FOB3}, based on the operation voltage VDD applied to the third connection signal line 30. Thereafter, the third latch 520c applies the pulse signal to the fourth latch 520d. When the third latch 520c applies the pulse signal to the fourth latch 520d, the third latch 520c stops applying the operation voltage VDD to the third connection signal line. That is, the third latch 520c opens the third connection signal line 30.

The fourth latch 520d short-circuits the fourth connection signal line 40 in response to the pulse signal applied from the third latch 520c, to apply the operation voltage VDD to the fourth connection signal line 40. The remaining signal lines 10, 20, and 30, except for the fourth connection signal line 40, are in an open state. Thereafter, the signal controller 600 determines an error of each of the resistances R_{COG4}, R_{FOG4}, and R_{FOB4}, based on the operation voltage VDD applied to the fourth connection signal line 40.

That is, each of the latches 520a, 520b, 520c, and 520d of each of the D-ICs 510a, 510b, 510c, and 510d, respectively applies the operation voltage VDD to each of the connection signal lines 10, 20, 30, and 40, based on the applied pulse signal. The signal controller 600 determines an error of each of the resistances R_{COG1-4}, R_{FOG1-4}, and R_{FOB1-4}, based on the operation voltage VDD applied to the each of the connection signal lines 10, 20, 30, and 40. Thereafter, each of the latches 520a, 520b, 520c, and 520d transfers the applied pulse signal to the next latch. Through this method, the display device according to an embodiment of the present invention may determine an error of the resistances R_{COG}, R_{FOG}, and R_{FOB} of all the connection signal lines.

FIG. 3 is a diagram schematically illustrating a connection relationship between a D-IC and a signal controller, when a VDD is applied to any one connection signal line of the display device of an embodiment of FIG. 2.

FIG. 3 illustrates a case where the first connection signal line 10 is short-circuited, but the present invention is not limited thereto.

When the first connection signal line 10 is short-circuited, an equivalent circuit may be formed as illustrated in FIG. 3, because the other connection signal lines 20, 30, and 40 are opened. That is, according to an embodiment of the present invention, when any one of the plurality of connection signal lines 10, 20, 30, and 40 is short-circuited, other connection signal lines are opened, and as a result, a substantially equivalent circuit as shown in the embodiment of FIG. 3 is formed.

The signal controller 600 may calculate the respective resistances R_{COG1}, R_{FOG1}, and R_{FOB1} according to (e.g., based on) the following Equations 1 to 3. According to an embodiment of the present invention, the resistance measuring unit 900 of the signal controller 600 may also calculate respective resistances R_{COG1}, R_{FOG1}, and R_{FOB1} according to the following Equations 1 to 3.

V_{P1}=(VDD*R_{T1})/((R_{COG1}+R_{FOG1}+R_{FOB1})+R_{T1}) Equation 1

(V_{P1} is a contact point voltage of R_{FOB1} and R_{T1}, R_{T1}=R_{T2}=R_{T3})

V_{P2}=(VDD*R_{T1})/((R_{COG1}+R_{FOG1})+R_{T1}) Equation 2

(V_{P2} is a contact point voltage of R_{FOB1} and R_{FOG1}, R_{T1}=R_{T2}=R_{T3})

V_{P3}=(VDD*R_{T1})/((R_{COG1})+R_{T1}) Equation 3

(V_{P3} is a contact point voltage of R_{FOG1} and R_{COG1}, R_{T1}=R_{T2}=R_{T3})

In detail, the resistance measuring unit 900 calculates V_{P1}, V_{P2}, and V_{P3}. Thereafter, the R_{COG1}, R_{FOG1}, and R_{FOB1} are calculated according to Equations 1 to 3. The signal controller 600 determines an error of each of the resistances R_{COG1}, R_{FOG1}, and R_{FOB1} according to (e.g., based on) the calculated R_{COG1}, R_{FOG1}, and R_{FOB1} values. When the signal controller 600 determines the error of each of the resistances R_{COG1}, R_{FOG1}, and R_{FOB1}, the signal controller 600 may determine a case where the size of each of the resistances R_{COG1}, R_{FOG1}, and R_{FOB1} is larger than a set (e.g., predetermined) value as the error. Further, when the signal controller 600 determines the error of each of the resistances R_{COG1}, R_{FOG1}, and R_{FOB1}, the signal controller 600 may determine a case where the size of each of the resistances R_{COG1}, R_{FOG1}, and R_{FOB1} is smaller than a set value as the error.

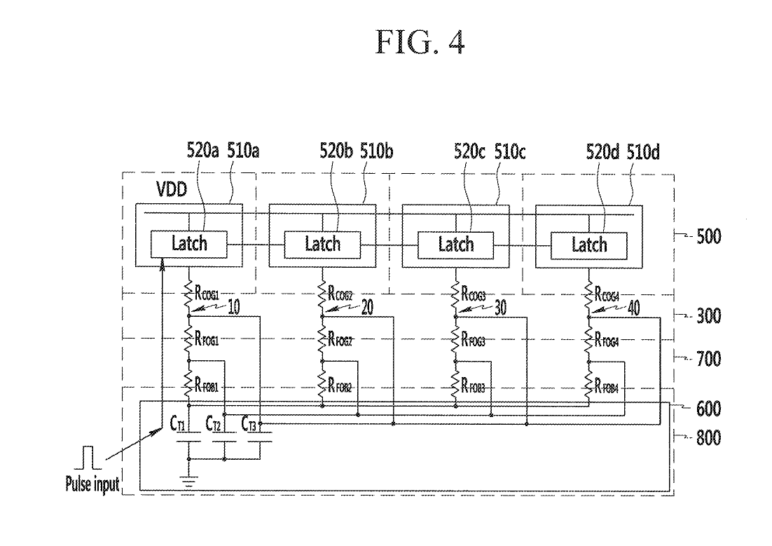

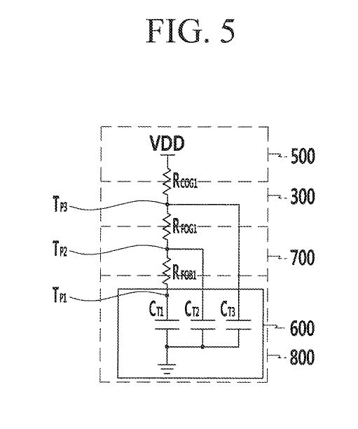

Next, an operating method of the display device according to another embodiment of the present invention will be described with reference to FIGS. 4 and 5.

FIG. 4 is a diagram schematically illustrating a display device according to another embodiment of the present invention.

A configuration of the display device according to an embodiment of the present invention will be described with reference to FIG. 4. The D-ICs 510a, 510b, 510c, and 510d may include latches 520a, 520b, 520c, and 520d, respectively. Further, the D-ICs 510a, 510b, 510c, and 510d may be coupled to (e.g., connected to) the signal controller 600 through the connection signal lines 10, 20, 30, and 40, respectively.

Each of the connection signal lines 10, 20, 30, and 40 may include a COG resistance R_{COG1-4}, a FOG resistance R_{FOG1-4}, and a FOB resistance R_{Fog1-4}, which may be respectively coupled to each other in series.

The signal controller 600 may include first to third capacitors C_{T1}, C_{T2}, and C_{T3}, which may be coupled to each other in parallel. The sizes of the first to third capacitors C_{T1}, C_{T2}, and C_{T3}, according to an embodiment of the present invention, may be the same as each other. Further, the first to third capacitors C_{T1}, C_{T2}, and C_{T3} may be constants. One end of the first capacitor C_{T1} may be coupled to one end of each FOB resistance R_{FOB1-4}. The other end of each FOB resistance R_{FOB1-4} may be respectively coupled to one end of each FOG resistance R_{FOG1-4}. Further, the one end of each FOG resistance R_{FOG1-4} may also be coupled to one end of the second capacitor C_{T2}. The other end of each FOG resistance R_{FOG1-4} may be respectively coupled to one end of each COG resistance R_{COG1-4}. The other end of each FOG resistance R_{FOG1-4} may also be coupled to one end of the third capacitor C_{T3}. The other end of each COG resistance R_{COG1-4} may be respectively coupled to each of the D-ICs 510a, 510b, 510c, and 510d. The other ends of the first to third capacitors C_{T1}, C_{T2}, and C_{T3} may be grounded.

Next, an operation of the display device according to an embodiment of the present invention will be described.

The signal controller 600 applies a pulse signal to the first latch 520a. The first latch 520a short-circuits the first connection signal line 10 in response to the pulse signal, to apply an operation voltage VDD to the first connection signal line 10. The remaining signal lines 20, 30, and 40, except for the first connection signal line 10, are in an open state. Thereafter, the signal controller 600 determines an error of each of the resistances R_{COG1}, R_{FOG1}, and R_{FOB1}, based on the operation voltage VDD applied to the first connection signal line 10. Thereafter, the first latch 520a applies the pulse signal to the second latch 520b. When the first latch 520a applies the pulse signal to the second latch 520b, the first latch 520a stops applying the operation voltage VDD to the first connection signal line 10. That is, the first latch 520a opens the first connection signal line 10.

The second latch 520b short-circuits the second connection signal line 20 in response to the pulse signal applied from the first latch 520a, to apply the operation voltage VDD to the second connection signal line 20. The remaining signal lines 10, 30, and 40, except for the second connection signal line 20, are in an open state. Thereafter, the signal controller 600 determines an error of each of the resistances R_{COG2}, R_{FOG2}, and R_{FOB2}, based on the operation voltage VDD applied to the second connection signal line 20. Thereafter, the second latch 520b applies the pulse signal to the third latch 520c. When the second latch 520b applies the pulse signal to the third latch 520c, the second latch 520b stops applying the operation voltage VDD to the second connection signal line 20. That is, the second latch 520b opens the second connection signal line 20.

The third latch 520c short-circuits the third connection signal line 30 in response to the pulse signal applied from the second latch 520b, to apply the operation voltage VDD to the third connection signal line 30. The remaining signal lines 10, 20, and 40, except for the third connection signal line 30, are in an open state. Thereafter, the signal controller 600 determines an error of each of the resistances R_{COG3}, R_{FOG3}, and R_{FOB3}, based on the operation voltage VDD applied to the third connection signal line 30. Thereafter, the third latch 520c applies the pulse signal to the fourth latch 520d. When the third latch 520c applies the pulse signal to the fourth latch 520d, the third latch 520c stops applying the operation voltage VDD to the third connection signal line. That is, the third latch 520c opens the third connection signal line 30.

The fourth latch 520d short-circuits the fourth connection signal line 40 in response to the pulse signal applied from the third latch 520c, to apply the operation voltage VDD to the fourth connection signal line 40. The remaining signal lines 10, 20, and 30, except for the fourth connection signal line 40, are in an open state. Thereafter, the signal controller 600 determines an error of each of the resistances R_{COG4}, R_{FOG4}, and R_{FOB4}, based on the operation voltage VDD applied to the fourth connection signal line 40.

That is, each of the latches 520a, 520b, 520c, and 520d of each of the D-ICs 510a, 510b, 510c, and 510d, respectively applies the operation voltage VDD to each of the connection signal lines 10, 20, 30, and 40, based on the applied pulse signal. The signal controller 600 determines an error of each of the resistances R_{COG1-4}, R_{FOG1-4}, and R_{FOB1-4}, based on the operation voltage VDD applied to the each of the connection signal lines 10, 20, 30, and 40. Thereafter, each of the latches 520a, 520b, 520c, and 520d transfers the applied pulse signal to the next latch. Through this method, the display device according to an embodiment of the present invention may determine an error of the resistances R_{COG}, R_{FOG}, and R_{FOB} of all the connection signal lines.

FIG. 5 is a diagram schematically illustrating a connection relationship between a D-IC and a signal controller, when a VDD is applied to any one connection signal line of the display device of an embodiment of FIG. 4.

FIG. 5 illustrates a case where the first connection signal line 10 is short-circuited, but the present invention is not limited thereto.

When the first connection signal line 10 is short-circuited, an equivalent circuit may be formed as illustrated in FIG. 5, because the other connection signal lines 20, 30, and 40 are opened. That is, according to an embodiment of the present invention, when any one of the plurality of connection signal lines 10, 20, 30, and 40 is short-circuited, the other connection signal lines are opened, and as a result, a substantially equivalent circuit as shown in the embodiment of FIG. 5 is formed.

The signal controller 600 may calculate the respective resistances R_{COG1}, R_{FOG1}, and R_{FOB1} according to (e.g., based on) the following Equations 4 to 6. According to an embodiment of the present invention, the resistance measuring unit 900 of the signal controller 600 may also calculate respective resistances R_{COG1}, R_{FOG1}, and R_{FOB1} according to the following Equations 4 to 6.

T_{P1}=a*((R_{COG1}+R_{FOG1}+R_{FOB1})*C_{T1}) Equation 4
(T_{P1} is a target voltage delay time of a contact point of R_{FOB1} and C_{T1}, C_{T1}=C_{T2}=C_{T3}, and a is a coefficient)

T_{P2}=a*((R_{COG1}+R_{FOG1})+C_{T1}) Equation 5
(T_{P2} is a target voltage delay time of a contact point of R_{FOB1} and R_{FOG1}, C_{T1}=C_{T2}=C_{T3}, and a is a coefficient)

T_{P3}=a*((R_{COG1})+C_{T1}) Equation 6
(T_{P3} is a target voltage delay time of a contact point of R_{FOG1} and R_{COG1}, C_{T1}=C_{T2}=C_{T3}, and a is a coefficient)

In detail, the resistance measuring unit 900 calculates T_{P1}, T_{P2}, and T_{F3}. Thereafter, the R_{COG1}, R_{FOG1}, and R_{FOB1} are calculated according to Equations 1 to 3. The signal controller 600 determines an error of the respective resistances R_{COG1}, R_{FOG1}, and R_{FOB1} according to (e.g., based on) the calculated R_{COG1}, R_{FOG1}, and R_{FOB1} values. When the signal controller 600 determines the error of each of the resistances R_{COG1}, R_{FOG1}, and R_{FOB1}, the signal controller 600 may determine a case where the size of each of the resistances R_{COG1}, R_{FOG1}, and R_{FOB1} is larger than a set (e.g., predetermined) value as the error. Further, when the signal controller 600 determines the error of each of the resistances R_{COG1}, R_{FOG1}, and R_{FOB1}, the signal controller 600 may determine a case where the size of each of the resistances R_{COG1}, R_{FOG1}, and R_{FOB1} is smaller than a set value as the error.

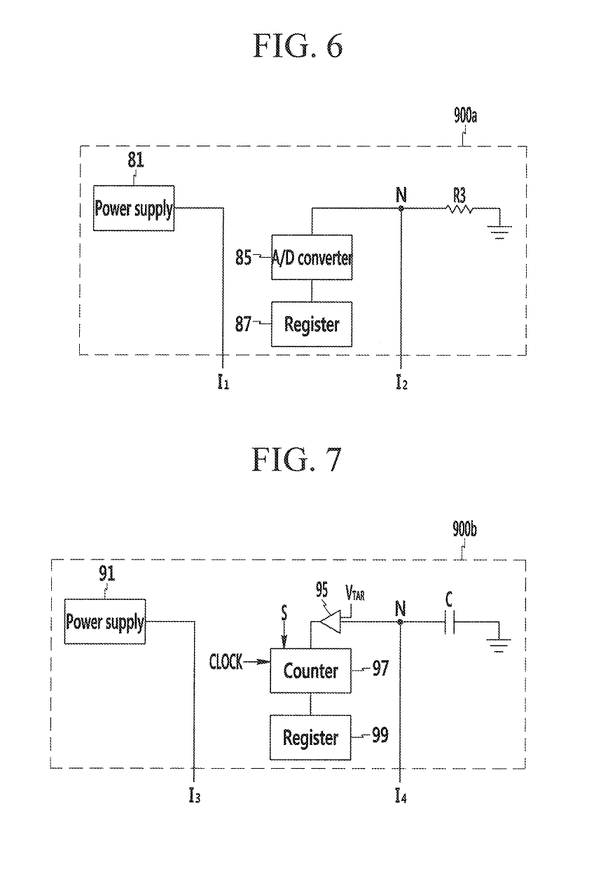

Next, a resistance measuring unit according to an embodiment of the present invention will be described with reference to FIGS. 6 to 8.

FIG. 6 is a diagram schematically illustrating a resistance measuring unit according to an embodiment of the present invention.

Referring to FIG. 6, a resistance measuring unit 900a may measure respective resistances R_{COG1-4}, R_{FOG1-4}, and R_{FOB1-4}. The resistance measuring unit 900a may include a power supply 81, an A/D converter 85, a register 87, and a resistance R3.

The power supply 81 may be coupled to (e.g., connected to) a first input terminal I₁. Further, the power supply 81 may provide a power voltage V_IC, and thus, the respective resistance R_{COG1-4}, R_{FOG1-4}, and R_{FOB1-4} currents flow. The power supply 81 may be an internal voltage of a driving IC, that is, a driving voltage VDD.

The A/D converter 85 may measure a voltage V_N at a measuring node N, to convert the measured voltage V_N into a digital value. The voltage V_N at the measuring node N is changed according to each of the resistances R_{COG1-4}, R_{FOG1-4}, and R_{FOB1-4}. A second input terminal I₂ is connected to the measuring node N according to an embodiment of the present invention. A contact point of R_{FOB1} and R_{T1}, a contact point of R_{FOB1} and R_{FOG1}, or a contact point of R_{FOG1} and R_{COG1} may be coupled to (e.g., connected to) the second input terminal I₂, according to an embodiment of the present invention.

The register 87 may store a digital voltage value of the measuring node N received from the A/D converter 85. The stored digital voltage value may be read by an external controller through an IC interface and displayed on a monitor. A CPU interface, a serial interface, and the like may be used (e.g., utilized) as the IC interface.

The resistance measuring unit 900a may calculate V_{P1}, V_{P2 and} V_{P3} by measuring the voltage V_N at the measuring node N, and may calculate respective resistances R_{COG1-4}, R_{FOG1-4}, and R_{FOB1-4} according to (e.g., based on) the calculated V_{P1}, V_{P2}, and V_{P3}. The resistance measuring unit 900a may use (e.g., utilize) Equations 1 to 3 when measuring the respective resistances R_{COG1-4}, R_{FOG1-4}, and R_{FOB1-4} according to the V_{P1}, V_{P2}, and V_{P3}. Further, the resistance measuring unit 900a may store the calculated respective resistances R_{COG1-4}, R_{FOG1-4}) and R_{FoB1-4} in the register 87. The stored resistance values may be read by an external controller through an IC interface and displayed on a monitor. A CPU interface, a serial interface, and the like may be used (e.g., utilized) as the IC interface.

FIG. 7 is a diagram schematically illustrating a resistance measuring unit according to another embodiment of the present invention.

Referring to FIG. 7, a resistance measuring unit 900b according to another embodiment of the present invention measures respective resistances R_{COG1-4}, R_{FOG1-4}, and R_{FOB1-4}.

The resistance measuring unit 900b may include a power supply 91, a comparator 95, a counter 97, a register 99, and a capacitor C.

The power supply 91 may be coupled to (e.g., connected to) a third input terminal I₃. Further, the power supply 91 may provide a power voltage V_IC, and thus, respective resistance R_{COG1-4}, R_{FOG1-4}, and R_{FOB1-4} currents flow. The power supply 81 may be an internal voltage of a driving IC, that is, a driving voltage VDD.

The comparator 95 may measure the voltage V_N at the measuring node N, to compare the measured voltage V_N with a V_TAR. A fourth input terminal I₄ is coupled to the measuring node N according to an embodiment of the present invention. A contact point of R_{FOB1} and C_{T1}, a contact point of R_{FOB1} and R_{FOG1}, or a contact point of R_{FOG1} and R_{COG1} is coupled to the fourth input terminal I₄ according to an embodiment of the present invention.

The counter 97 may be activated by a start signal S, to count a time until the voltage value of the measuring node N reaches a target voltage value, by using a clock signal CLOCK, and converts a count value into a digital value. A voltage V_N delay time at the measuring node N may be verified by using (e.g., utilizing) the count value. The voltage V_N delay time at the measuring node N may be changed according to each of the resistances R_{COG1-4}, R_{FOG1-4}, and R_{FOB1-4}.

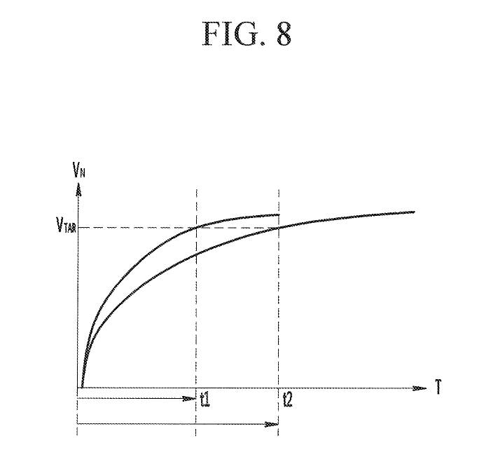

FIG. 8 is a diagram illustrating a voltage delay of the measuring node N of an embodiment of the present invention shown in FIG. 7.

FIG. 8 is a graph illustrating a voltage V_N delay in the measuring node N according to each of the resistances R_{COG1-4}, R_{FOG1-4}, and R_{FOB1-4}. A delay time t1 (e.g., the time until the voltage V_N of the measuring node N reaches a target voltage V_TAR) when each of the resistances R_{COG1-4}, R_{FOG1-4}, and R_{FOB1-4} is small, may be smaller than a delay time t2 (e.g., the time until the voltage V_N of the measuring node N reaches the target voltage V_TAR) when each of the resistances R_{COG1-4}, R_{FOG1-4}, and R_{FOB1-4} is large. That is, it may be verified that the delay time until the voltage V_N of the measuring node N reaches the target voltage V_TAR is shorter as each of the resistances R_{COG1-4}, R_{FOG1-4}, and R_{FOB1-4} is smaller.

Referring back to FIG. 7, the resistance measuring unit 900b will be described.

The register 99 stores a count value received from the counter 97. The stored count values are read by an external controller through an IC interface and displayed on a monitor. A CPU interface, a serial interface, and the like may be used (e.g., utilized) as the IC interface.

The resistance measuring unit 900b may calculate T_{P1}, T_{P2}, and T_{P3} at the measuring node N, and calculate respective resistances R_{COG1-4}, R_{FOG1-4}, and R_{FOB1-4} according to (e.g., based on) the calculated T_{P1}, T_{P2}, and T_{P3}. The resistance measuring unit 900b may use (e.g., utilize) Equations 4 to 6 when calculating the respective resistances R_{COG1-4}, R_{FOG1-4}, and R_{FOB1-4} based on the T_{P1}, T_{P2}, and T_{P3}. Further, the calculated resistance values are read by an external controller through an IC interface and displayed on a monitor. The respective resistances R_{COG1-4}, R_{FOG1-4}, and R_{FOB1-4} may be stored in the register 99. A CPU interface, a serial interface, and the like may be used (e.g., utilized) as the IC interface.

Description of symbols

| | | | |
|---|---|---|---|
| 10: | First connection signal line | 20: | Second connection signal line |
| 30: | Third connection signal line | 40: | Fourth connection signal line |
| 300: | Display panel | 310: | Display area |
| 400: | Gate driver | 500: | Data driver |
| 520: | Latch | 600: | Signal controller |
| 700: | FPC | 800: | Circuit board |
| 81: | Power supply | 85: | A/D converter |
| 87: | Register | 900: | Resistance measuring unit |
| 91: | Power supply | 95: | Comparator |
| 97: | Counter | 99: | Register |

What is claimed is:

1. A display device, comprising:
a circuit board comprising a signal controller;
a display panel comprising a plurality of driving IC circuits;
a flexible printed circuit board configured to couple the circuit board to the display panel; and
a plurality of signal lines respectively coupled to the signal controller and the plurality of driving IC circuits through the circuit board, the flexible printed circuit board, and the display panel,
wherein each of the plurality of signal lines comprises a COG resistance by coupling of the display panel and the driving IC circuit, a FOG resistance by coupling of the display panel and the flexible printed circuit board, and a FOB resistance by coupling of the flexible printed circuit board and the circuit board,
the signal controller is configured to apply a first signal to any one of the plurality of driving IC circuits,
the any one of the plurality of driving IC circuits configured to short-circuit the respectively coupled signal line when the first signal is received, and
the signal controller is further configured to measure the COG resistance, the FOG resistance, and the FOB resistance when the respectively coupled signal line is short-circuited.

2. The display device of claim 1, wherein each of the plurality of driving IC circuits comprises a latch.

3. The display device of claim 2, wherein the latch is configured to receive the first signal to short-circuit the signal line coupled to the driving IC circuit comprising the latch, and to apply an operation voltage VDD to the coupled signal line.

4. The display device of claim 3, wherein the latch is further configured to transfer the first signal to a next latch, and to open the short-circuited signal line when the signal controller measures a first coupling resistance, a second coupling resistance, and a third coupling resistance of the short-circuited signal line.

5. The display device of claim 4, wherein:
the signal controller comprise first to third resistances, and the first resistance is coupled to the FOB resistance, the second resistance is coupled to the FOG resistance, and the third resistance is coupled to the COG resistance.

6. The display device of claim 5, wherein the first to third resistances are a same size as each other.

7. The display device of claim 6, wherein:
the signal controller is configured to measure a contact point voltage V_{P1} of the FOB resistance and the first resistance, a contact point voltage V_{P2} of the FOB resistance and the FOG resistance, and a contact point voltage V_{P3} of the FOG resistance and the COG resistance, and
the signal controller is further configured to measure the FOB resistance, the FOG resistance, and/or the COG resistance according to Equations 1 to 3:
V_{P1}=(VDD*first resistance)/((COG resistance+FOG resistance+FOB resistance)+first resistance) Equation 1
V_{P2}=(VDD*first resistance)/((COG resistance+FOG resistance)+first resistance) Equation 2
V_{P3}=(VDD*first resistance)/((COG resistance+first resistance). Equation 3

8. The display device of claim 7, wherein the signal controller further comprises
a resistance measuring unit configured to measure the FOB resistance, the FOG resistance, and/or the COG resistance.

9. The display device of claim 8, wherein the resistance measuring unit comprises:
an A/D converter configured to convert a measured voltage value into a digital value by measuring the V_{P1}, the V_{P2}, and the V_{P3}; and
a register configured to store the measured voltage value converted into the digital value.

10. The display device of claim 9, wherein the resistance measuring unit
is configured to measure the FOB, FOG, and/or COG resistances based on Equations 1 to 3.

11. The display device of claim 4, wherein:
the signal controller comprise first to third capacitors, and
the first capacitor is coupled to the FOB resistance, the second capacitor is coupled to the FOG resistance, and the third capacitor is coupled to the COG resistance.

12. The display device of claim 11, wherein the first to third capacitors are a same size as each other.

13. The display device of claim 12, wherein:
the signal controller is configured to measure
a target voltage delay time T_{P1} of the contact point voltage of the FOB resistance and the first capacitor, a target voltage delay time T_{P2} of the contact point voltage of the FOB resistance and the FOG resistance, and a target voltage delay time T_{P3} of the contact point voltage of the FOG resistance and the COG resistance, and
the signal controller is further configured to measure the FOB resistance, the FOG resistance, and/or the COG resistance based on Equations 4 to 6:
T_{P1}=a*((COG resistance+FOG resistance+FOB resistance)+first capacitor) Equation 4
(wherein a is a coefficient)
T_{P2}=a*((COG resistance+FOG resistance)+first capacitor) Equation 5
(wherein a is a coefficient)
T_{P3}=a*((COG resistance)+first capacitor) Equation 6
(wherein a is a coefficient).

14. The display device of claim 13, wherein the signal controller further comprises
a resistance measuring unit configured to measure the FOB resistance, the FOG resistance, and the COG resistance.

15. The display device of claim 14, wherein the resistance measuring unit further comprises:
a comparator configured to compare measured voltage values with a target voltage, by measuring a contact point voltage of the FOB resistance and the first capacitor, a contact point voltage of the FOB resistance and the FOG resistance, and a contact point voltage of the FOG resistance and the COG resistance; and
a counter configured to measure the T_{P1}, the T_{P2}, and the T_{P3}; and
a register configured to store the measured delay times.

16. The display device of claim 15, wherein the resistance measuring unit
is configured to measure the FOB, FOG, and/or COG resistances based on Equations 4 to 6.
